(19) United States
(12) Patent Application Publication
(10) Pub. No.: US 2014/0174588 A1
(43) Pub. Date: Jun. 26, 2014

(54) CONTAMINATED HYDROGEN CHARGING PREVENTING SYSTEM

(71) Applicant: HYUNDAI MOTOR COMPANY, Seoul (KR)

(72) Inventor: Chul Ho Yim, Suwon (KR)

(73) Assignee: HYUNDAI MOTOR COMPANY, Seoul (KR)

(21) Appl. No.: 13/798,869

(22) Filed: Mar. 13, 2013

(30) Foreign Application Priority Data
Dec. 21, 2012 (KR) 10-2012-0150321

(51) Int. Cl. F17C 5/00

(52) U.S. Cl. CPC F17C 5/007
USPC 141/1; 141/83

(57) ABSTRACT

A contaminated hydrogen charging preventing system that prevents contaminated hydrogen from being supplied to a vehicle. In particular, a sensor that is disposed in a charging pipe that charges a hydrogen tank of a vehicle with senses/detects contaminates in the hydrogen. Upon sensing contaminated hydrogen, a controller configured to control a cutoff valve is controlled to close charging pipe so that the contaminated hydrogen cannot be supplied to the vehicle. In addition, a hydrogen charging station may also terminate the flow of hydrogen to a dispenser based upon receiving contaminated hydrogen information from the controller within the vehicle.

### CROSS-REFERENCE TO RELATED APPLICATION

This application claims under 35 U.S.C. §119(a) the benefit of Korean Patent Application No. 10-2012-0150321 filed Dec. 21, 2012, the entire contents of which are incorporated herein by reference.

### BACKGROUND

(a) Technical Field

The present invention relates to a technology that prevents a vehicle from being charged with contaminated hydrogen during charging.

(b) Background Art

A fuel cell stack of a fuel cell vehicle requires hydrogen to operate. Accordingly, the vehicle must be charged with hydrogen much like internal combustion vehicles are filled up with fuel or gas. In particular, fuel cell vehicles should be charged with pure hydrogen i in order to prevent deterioration of a fuel cell stack Impure gases such as carbon oxide or contaminants, which may be contained in the process of making hydrogen, may exist in the hydrogen in hydrogen charge stations. When a fuel cell vehicle is charged with the hydrogen that includes contaminants, adverse effects such as deterioration of a catalyst within the fuel cell stack may occur.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the problems described above and an object of the present invention is to provide a contaminated hydrogen charging preventing system which can ensure durability of a fuel cell stack by preventing deterioration of the fuel cell stack due to charging the vehicle with contaminated hydrogen, by sensing the contaminated hydrogen during charging at an early stage and stopping the charging with the contaminated hydrogen, once the controller has detected that a vehicle is being charged with the contaminated hydrogen.

In order to achieve the objects of the present invention, a contaminated hydrogen charging preventing system includes: a sensor that is disposed in a charging pipe that charges a hydrogen tank of a vehicle with hydrogen and is configured to detect contaminates in the hydrogen; a cutoff valve that opens/closes the charging pipe; and a controller configured to control the cutoff valve in response to a signal from the sensor. The controller may be a specialized controller that is specifically implemented to monitor vehicle hydrogen charging or alternatively may be a high level controller that is configured among other things to monitor vehicle hydrogen charging.

Further, in order to achieve the objects of the present invention, a hydrogen charge station includes: a dispenser that charges a vehicle with hydrogen; a charge station cutoff valve that opens and closes a supply channel to the dispenser; and a vehicle charging controller that controls the cutoff valve to terminate the supply of hydrogen to the dispenser, upon determining by the controller that the hydrogen is contaminated, upon receiving contaminated gas information transmitted from the vehicle.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view showing an embodiment of a contaminated hydrogen charging preventing system according to the exemplary embodiment of the present invention;

FIG. 2 is a view showing only a vehicle side part of the contaminated hydrogen charging preventing system of FIG. 1; and

FIG. 3 is a view showing only a hydrogen charge station part of the contaminated hydrogen charging preventing system of FIG. 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

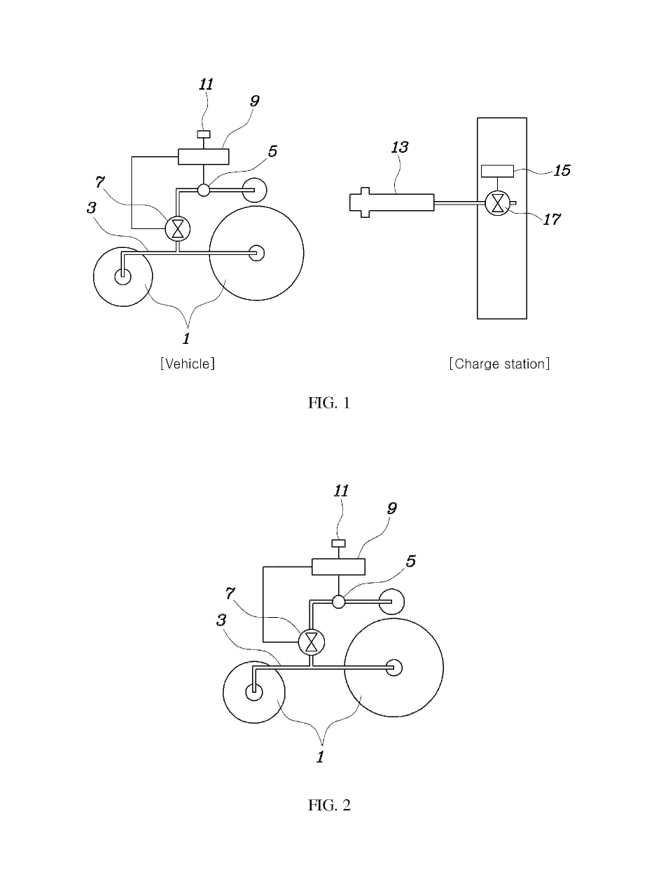

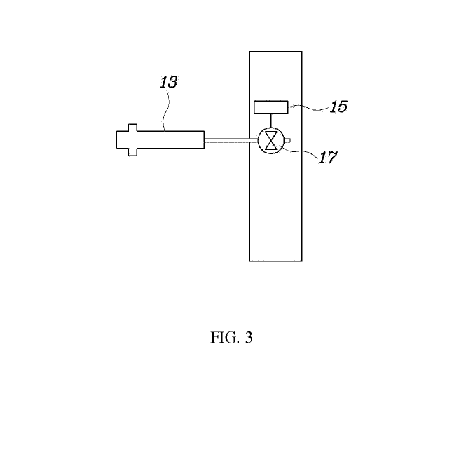

Referring to FIGS. 1 to 3, a contaminated hydrogen charging preventing system according to an exemplary embodiment of the present invention includes: a contaminated gas sensor 5 that is disposed in a charging pipe 3 for charging a hydrogen tank 1 of a vehicle with hydrogen; a cutoff valve 7 that can open/close the charging pipe 3; and a vehicle charging controller 9 that is configured to control the cutoff valve 7 in response to a signal from the contaminated gas sensor 5.

That is, when the hydrogen tank 1 of a vehicle is about to be charged with hydrogen, the contaminated gas sensor 5 senses a contamination state of hydrogen flowing into the vehicle and sends the information to the vehicle charging controller 9, the vehicle charging controller 9 controls whether to keep charging or stop charging the vehicle by opening/closing the cutoff valve 7 in accordance with whether the charging hydrogen is contaminated, and stops charging when contaminated hydrogen is detected. Advantageously, it is possible to prevent deterioration of a fuel cell stack mounted on a vehicle.

The cutoff valve 7 may be preferably disposed between the contaminated gas sensor 5 of the charging pipe 3 and the hydrogen tank 1. That is, when the contaminated gas sensor 5 senses that the charging hydrogen is contaminated, in the early stage of being charged with the hydrogen, the vehicle charging controller 9 immediately closes the cutoff valve 7, therefore charging of the hydrogen can be stopped while the contaminated hydrogen is prevented from flowing into the hydrogen tank 1 even though the hydrogen has passed the contaminated gas sensor 5.

The vehicle charging controller 9 is also preferably connected with a transmitter 11 which can transmit the information that the contaminated gas sensor 5 has detected contaminated hydrogen, to the charge station. That is, when the vehicle charging controller 9 receives the information about a contaminated hydrogen gas from the contaminated gas sensor 5 and closes the cutoff valve 7, the flow path of the hydrogen supplied to a vehicle from a dispenser at the charge station is closed, so it is preferable to also stop the dispenser from providing additional hydrogen by transmitting the information to the charge station, if possible.

Therefore, the charge station may also be provided with a charge station controller 15 that executes an instruction to terminate the flow of hydrogen that is being supplied to the dispenser 13 s upon receiving the contaminated gas information transmitted through the transmitter 11 from the vehicle charging controller 9 in the vehicle. More specifically, a charge station cutoff valve 17 is controlled by the charge station controller 15 to terminate the flow of hydrogen that is supplied to the vehicle. The cutoff valve is preferably installed on an upstream side of the dispenser 13. Therefore when the information relating to the contaminated hydrogen is transmitted from the vehicle, the charge station controller 15 immediately terminates charging by operating the charge station cutoff valve 17.

According to the contaminated hydrogen charging preventing system described above, it is possible to prevent deterioration of a fuel cell stack of a vehicle and improve the durability by precluding charging the vehicle with contaminated hydrogen. by sensing contaminated hydrogen during charging in the early stage and terminating the charging with the contaminated hydrogen while a vehicle is charged with the contaminated hydrogen.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A contaminated hydrogen charging preventing system comprising:
a sensor disposed in a hydrogen charging pipe for charging a hydrogen tank of a vehicle with hydrogen and configured to sense contaminated hydrogen;
a cutoff valve controlling whether the hydrogen charging pipe is open or closed; and
a vehicle charging controller configured to control the cutoff valve in response to a signal from the sensor.

2. The system of claim 1, wherein the cutoff valve is disposed between the sensor of the hydrogen charging pipe and the hydrogen tank.

3. The system of claim 1, wherein the vehicle charging controller is connected to a transmitter that transmits the information indicating that the sensor has sensed contaminated hydrogen to a charge station.

4. The system of claim 3, wherein the charge station is provided with:
a charge station controller that executes an instruction to terminate a flow of hydrogen that is supplied to the dispenser upon receiving contaminated gas information from the vehicle charging controller in the vehicle, and
a charge station cutoff valve that stops hydrogen that is supplied to the vehicle based on instructions from the charge station controller, the cutoff valve disposed on an upstream side of the dispenser.

5. A hydrogen charge station comprising:
a dispenser that charges a vehicle with hydrogen;
a charge station cutoff valve that controls a supply of hydrogen to the dispenser; and
a vehicle charging controller configured to terminate the supply of hydrogen to the dispenser by controlling the charge station cutoff valve, upon receiving contaminated gas information from the vehicle.

6. A method of preventing a fuel cell vehicle from receiving contaminated hydrogen, the method comprising:
receiving, by a controller within the fuel cell vehicle, a signal indicating that hydrogen being supplied to a charging pipe in the vehicle is contaminated; and
closing, by the controller within the vehicle, a cutoff valve disposed in the charging pipe of the vehicle in response to receiving the signal from the sensor.

7. The method of claim 6, further comprising:
in response to receiving a signal from the sensor indicating that the hydrogen is contaminated, transmitting information indicating that the hydrogen is contaminated to a controller at a hydrogen charging station; and
in response to receiving the information indicating that the hydrogen is contaminated, controlling, by the controller at the hydrogen charging station, a cutoff valve at the hydrogen charging station to terminate the supply of hydrogen to a dispenser.
